(19) United States
(12) Patent Application Publication
(10) Pub. No.: US 2009/0188617 A1
(43) Pub. Date: Jul. 30, 2009

(54) DOG NOSE ART

(76) Inventor: Susan R. Harsh, Fairfax, VA (US)

Correspondence Address: WOOD AND EISENBERG, PLLC, 6911 RICHMOND HIGHWAY, SUITE 403, Alexandria, VA, 22306, US

(21) Appl. No.: 12/350,916

(22) Filed: Jan. 8, 2009

Related U.S. Application Data
(60) Provisional application No. 61/023,427, filed on Jan. 25, 2008.

(51) Int. Cl. B32B 38/00

(52) U.S. Cl. 156/276

(57) ABSTRACT

A kit and method that converts dog nose smudges deposited on a first surface into a form of dog nose art on a second surface.

### CROSS-REFERENCE TO RELATED APPLICATIONS

This application claims the benefit of priority from U.S. Provisional Patent Application Ser. No. 61/023,427 (filed Jan. 25, 2008) the contents of which are incorporated herein by reference in its entirety.

### STATEMENT REGARDING FEDERALLY SPONSORED RESEARCH OR DEVELOPMENT

Not Applicable.

### FIELD OF THE INVENTION

This invention relates to animal art, and more specifically to dog nose art.

### BACKGROUND OF THE INVENTION

The domestic dog has been (and continues to be) one of the most widely-kept working and companion animals in human history. In the context of companion animals, dogs often become much loved and respected members of the human family unit. For single households a dog is often a treasured and beloved animal. A dog's life span is often numbered in less than 20 years and their human owners frequently outlive them. Many owners would like to have a permanent reminder of their beloved dog before they pass away. There is a need for kits or methods that enable dog owners to remember and/or celebrate their dogs in a decorative and artistic way.

### BRIEF DESCRIPTION OF THE DRAWINGS

FIG. 1 shows a dog art kit, according to the present invention.

FIG. 2 shows a brush with a bristle end being dabbed on dog nose powder held in container, according to the present invention.

FIG. 3 shows the dog nose powder of FIG. 2 being transferred to a dog nose, according to the present invention.

FIGS. 4 and 5 show the transfer of at least one dog nose smudge to a surface on a dog smudge display layer, according to the present invention.

FIG. 6 shows the arrangement of layers that make up a dog nose smudge laminate, according to one aspect of the present invention.

FIG. 7 shows an exemplar dog nose smudge laminate, according to the present invention.

FIG. 8 shows an exemplar dog nose smudge laminate with indicia and images disposed thereon, according to the present invention.

FIG. 9 shows an exemplar dog nose smudge laminate with indicia and images disposed thereon, according to the present invention.

FIG. 10 shows a “My Dog ‘Nose Art’” kit, according to the present invention.

FIG. 11 shows a dog about to contact its nose with a window surface.

FIG. 12 shows dog nose smudges deposited on the window surface of FIG. 11.

FIG. 13 shows sandpaper being used to generate dog nose powder from a piece of chalk, the dog nose powder being deposited on a cotton ball.

FIG. 14 shows the dog nose smudges deposited on the window surface depicted in FIG. 12.

FIG. 15 shows a cotton ball of FIG. 13 being used to powder at least one dog nose smudge located on a window surface.

FIG. 15A shows a brush of FIG. 1 being used to powder at least one dog nose smudge located on a window surface.

FIG. 16 shows dog smudges about to be transferred to the surface of a dog smudge display layer.

FIG. 17 shows the dog smudge display layer with dog nose smudges collected thereon.

FIG. 18 shows Table 1.

### SUMMARY OF THE INVENTION

A kit and method that converts dog nose smudges deposited on a first surface into a form of dog nose art on a second surface.

### DETAILED DESCRIPTION OF THE INVENTION

This invention is directed to animal art, and more specifically to dog nose art. Still more specifically, the invention is directed to providing a dog nose smudge laminate for people such as dog admirers who want a permanent reminder of a pet dog.

In a first embodiment of the invention a dog art kit 100 is provided to enable a dog lover or owner to obtain a permanent reminder of a beloved dog.

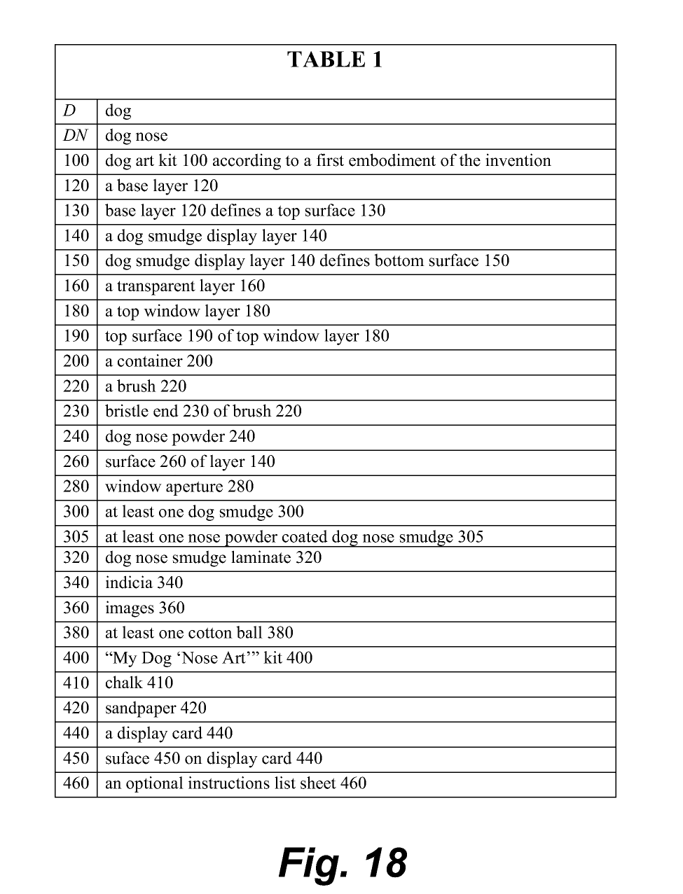

A summary of the component parts that make up the various embodiments of the present invention are listed in Table 1 (see FIG. 18).

It should be understood that the invention is devoted to displaying dog smudges in a dog nose smudge laminate 320 comprising at least one nose powder coated dog nose smudge 305.

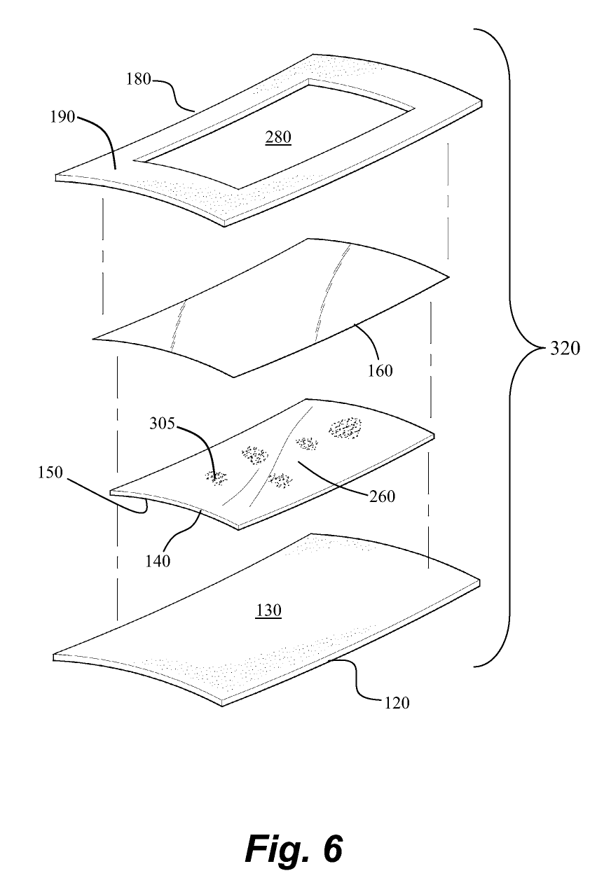

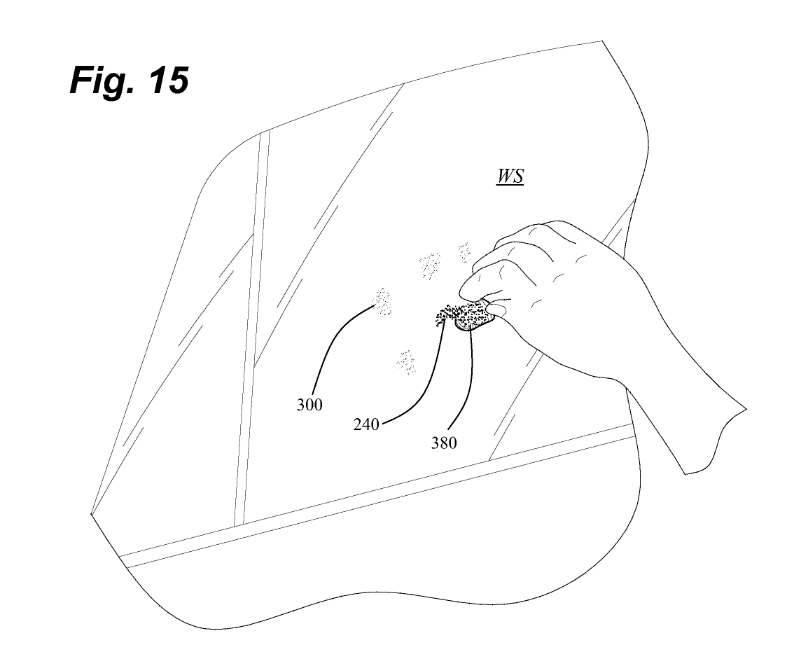

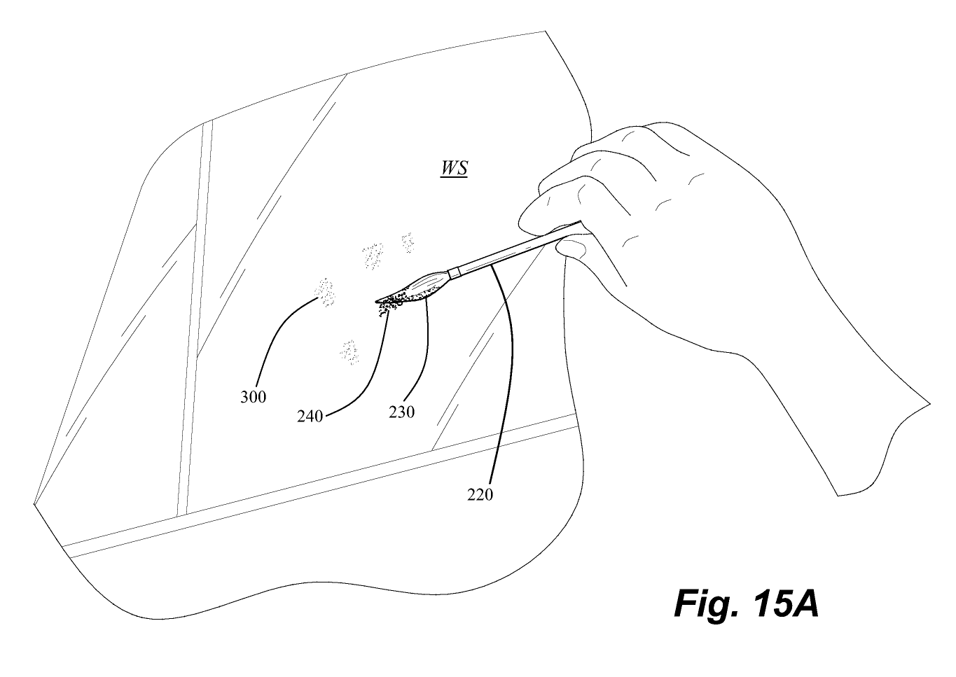

The invention comprises parts that make up the dog nose smudge laminate 320, and elements that enable a person to convert at least one dog smudge 300 into corresponding at least one nose powder coated dog nose smudge 305 by, for example, applying dog nose powder 240 (by means of, for example, at least one cotton ball 380 or a brush 220 as shown in FIGS. 15 and 15A, respectively) to at least one dog smudge 300 deposited on a first surface such as a window surface WS. Applying dog nose powder 240 to at least one dog smudge 300 converts the at least one dog smudge 300 to at least one nose powder coated dog nose smudge 305. The at least one nose powder coated dog nose smudge 305 are transferred to a second surface such as surface 260 of layer 140 (see, e.g., FIG. 6) which is used to form a dog nose smudge laminate 320 (see, e.g., FIGS. 6 through 9).

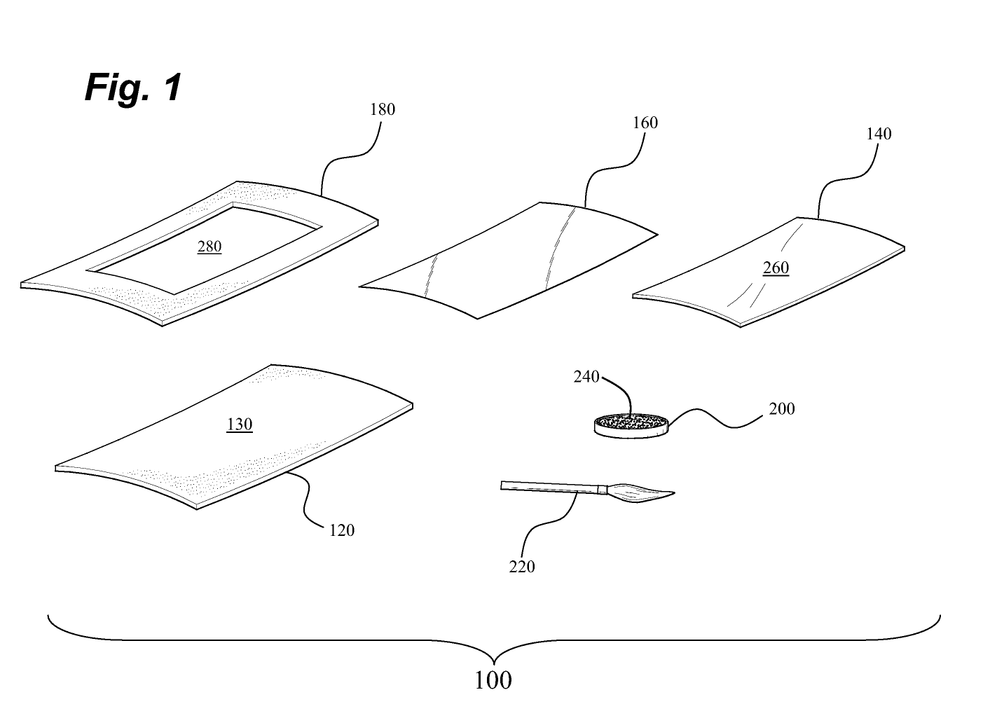

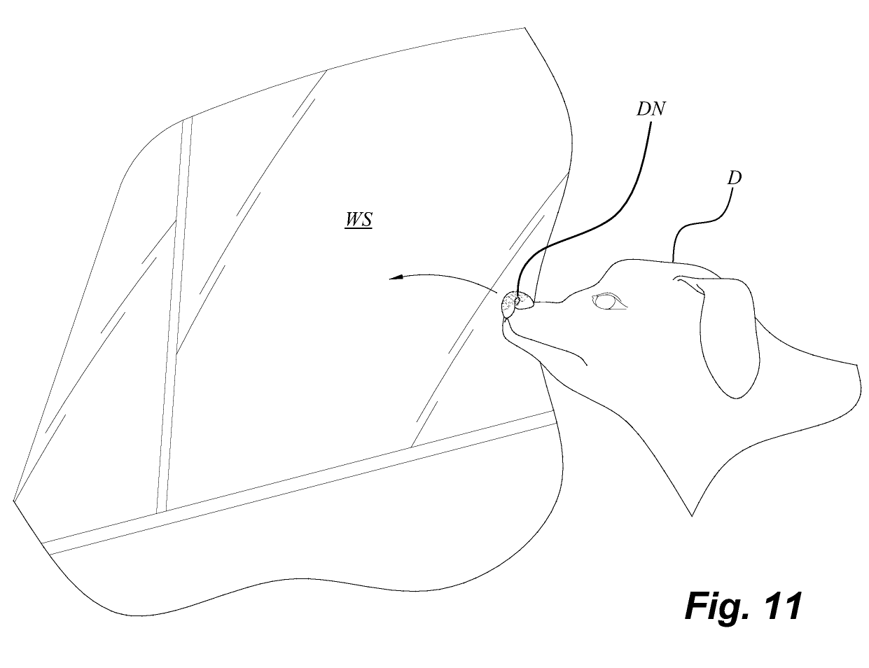

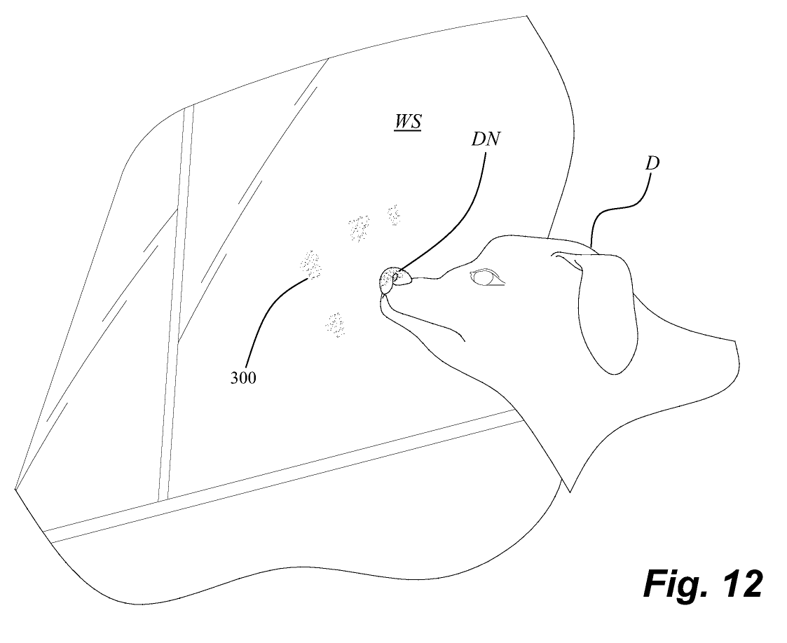

FIG. 1 shows the dog art kit 100 of the first embodiment of the invention, which is made up of a base layer 120, a dog smudge display layer 140, a transparent protective layer 160, a top window layer 180, a container 200 with dog nose powder 240 disposed therein, and a brush 220. One side of the dog smudge display layer 140 defines a second surface 260 (for purposes of description the first surface is whatever surface dog nose smudges 300 are disposed on such as a window surface WS (see, e.g., FIGS. 11 and 12); the terms “a second surface 260” and “surface 260” are hereinafter regarded as equivalent terms.

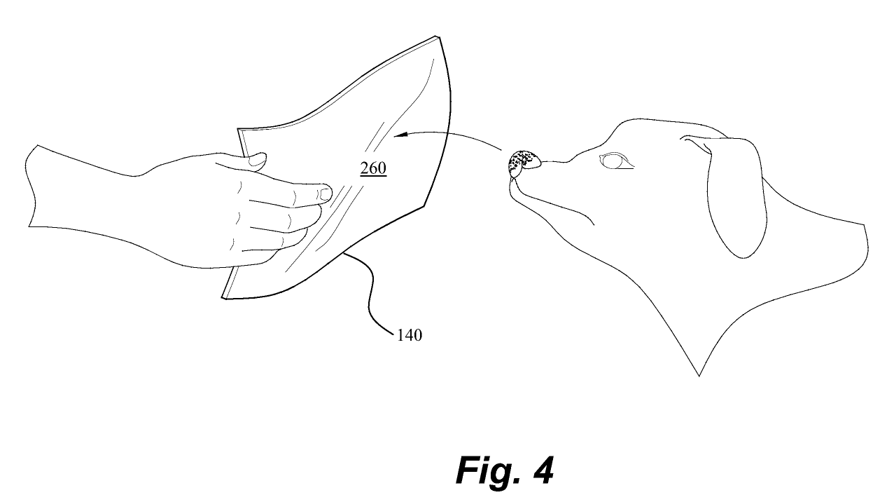

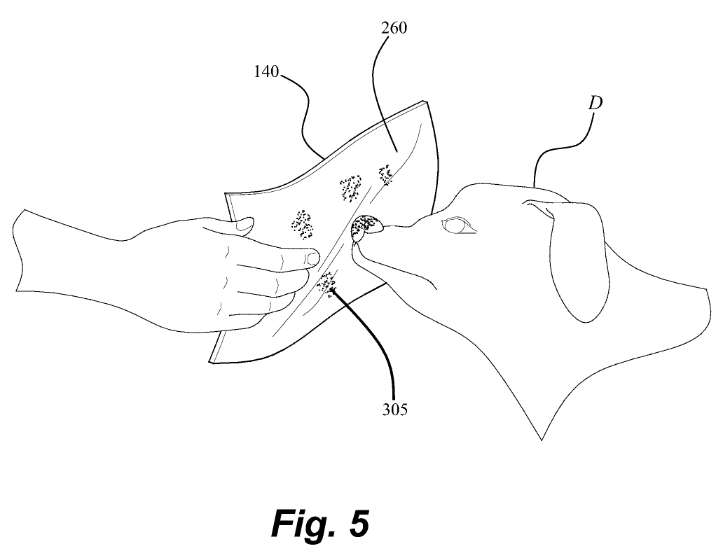

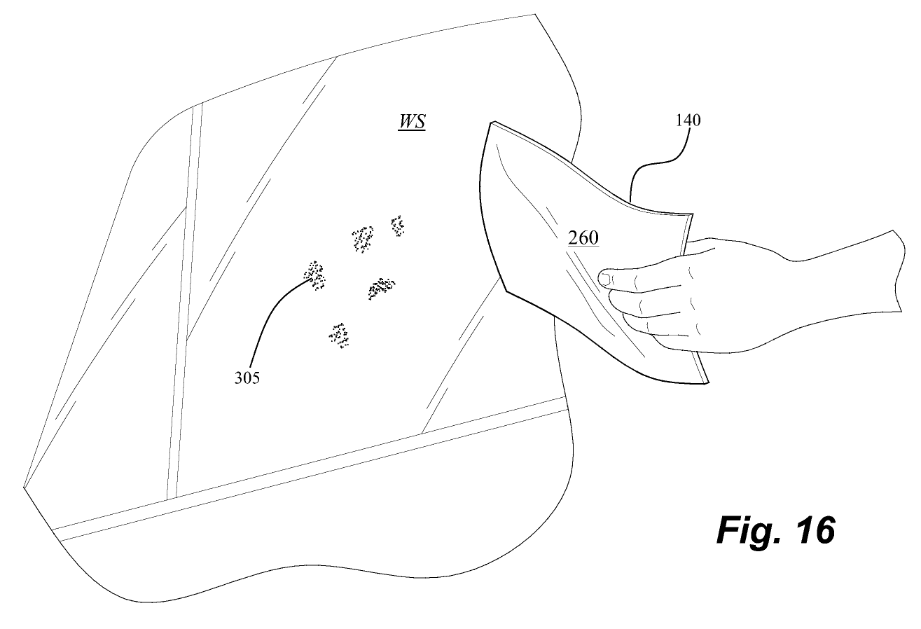

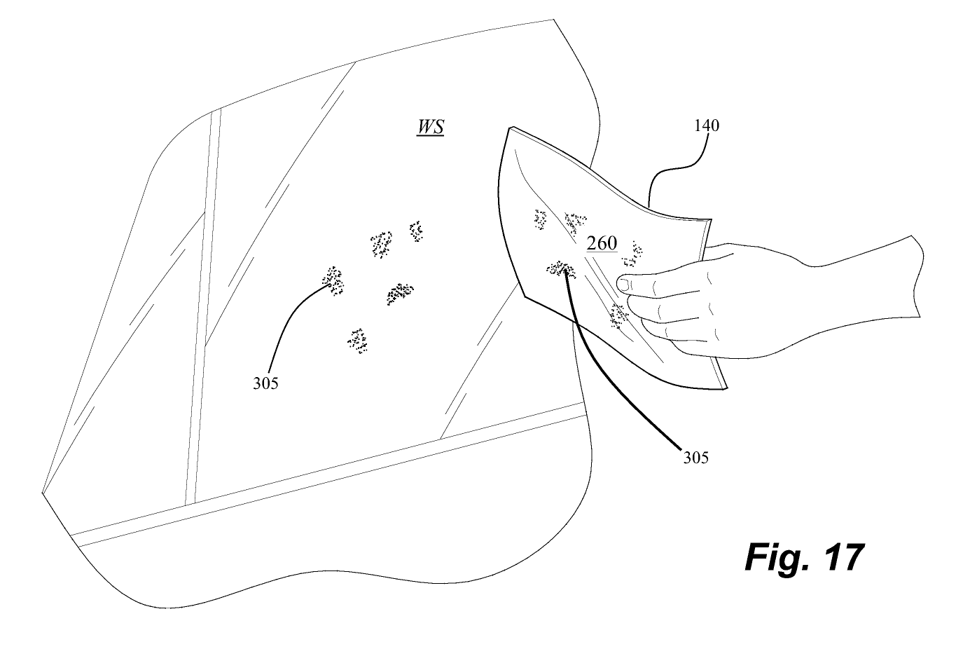

In practicing the invention at least one nose powder coated dog nose smudge 305 is transferred to the surface 260 either directly from the surface of a dog's nose (see, e.g., FIGS. 4 and 5) or from a first surface such as the surface of a glass window (e.g., patio glass windows see FIGS. 16 and 17) on which has been deposited at least one dog nose smudge 300 (see, e.g., a glass window surface as shown in, e.g., FIG. 14), which after coating with dog nose powder 240 to provide at least one nose powder coated dog nose smudge 305, the at least one nose powder coated dog nose smudge 305 are transferred to surface 260 (see FIGS. 16 and 17). The surface 260 can be any suitable surface providing it is capable of receiving and displaying at least one nose powder coated dog nose smudge 305.

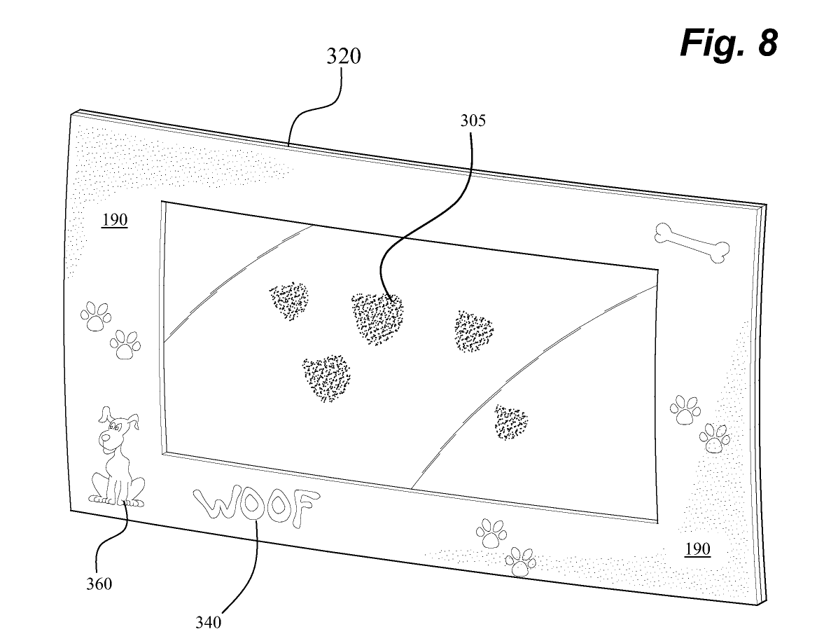

The top window layer 180 defines a top surface 190 (see FIG. 6). Desired indicia 340 and/or images 360 can be disposed as desired onto the top surface 190 of the top window layer 180 (see, e.g., FIG. 8). The top window layer 180 defines a window aperture 280, the perimeter of which is defined by the top surface layer 190. The window aperture 280 can be any suitable shape such as a rectangular shape as shown, for example, in FIG. 6. Alternatively, the window aperture 280 can have an overall oval shape. Other overall shapes for the window aperture 280 include, but are not limited to: regular polygonal shape, irregular polygonal shape.

The container 200 contains an amount of dog nose powder 240. The dog nose powder 240 plays a similar role to finger print powder of the kind used by finger print experts who use finger print powder to highlight human finger prints at crime scenes. The dog nose powder 240 is applied to at least one dog nose smudge 300 on a first surface to provide at least one nose powder coated dog nose smudge 305 that is then transferred to a second surface. In the preferred embodiment the second surface is surface 260 atop dog smudge display layer 140.

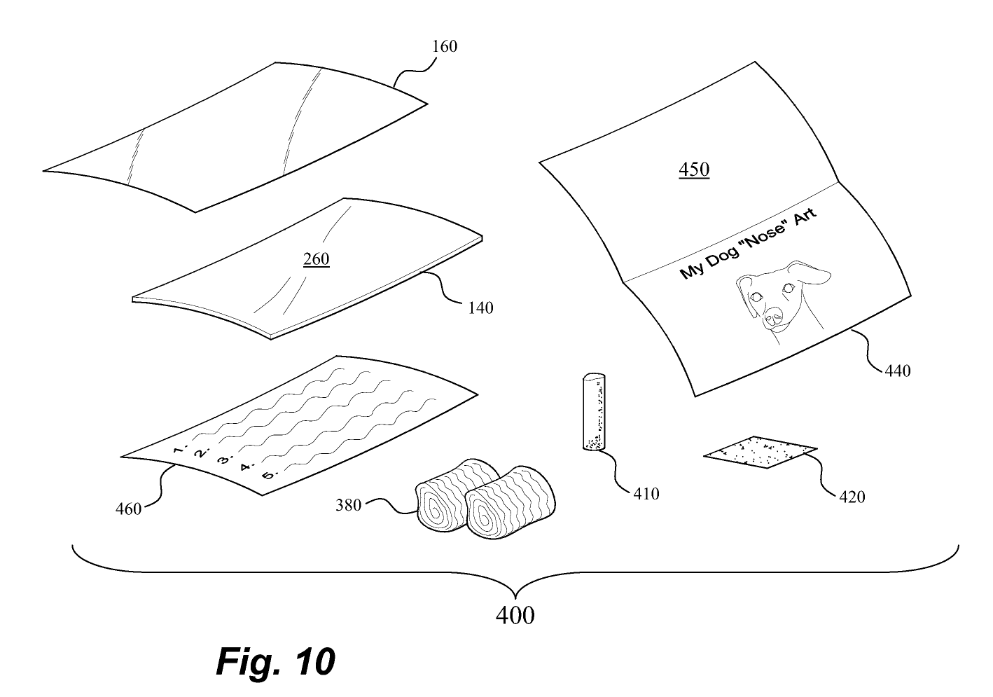

The dog nose powder 240 can be any suitable composition or material. For example, the dog nose powder 240 can be chalk powder (e.g., a pastel chalk powder) of any desired color so long as the color is sufficient to stand out relative to the background color of the dog smudge display layer 140. For example, a piece of chalk 410 (shown in, e.g., FIG. 10) can be used in place of container 200 and powder 240. The brush 220 is an optional part of kit 100—a person can use at least one cotton swab (e.g., Q-tips®) or at least one cotton ball (shown as part number “380” in FIG. 10).

The dog nose powder 240 can be made up of a mixture of soot collected from a candle flame mixed with starch powder, e.g., one part candle soot by volume for one part starch powder by volume. Alternatively the soot can be collected as a by-product from combustion such as wood, paper, coal, oil or coke combustion.

The dog nose powder 240 can be a mixture of talc and silica. Alternatively, the dog nose powder 240 can be a mixture of talc and silica in combination with a coloring agent such as a fluorescent dye, e.g., fluorescent naphthalimide dye. For example, the dog nose powder can be a mixture of about 25 to about 50% by weight talc and about 25 to about 60% by weight silica, and the coloring agent can be present in the dog nose powder in an amount ranging from about 10 to about 50% by weight of the total dog nose powder composition.

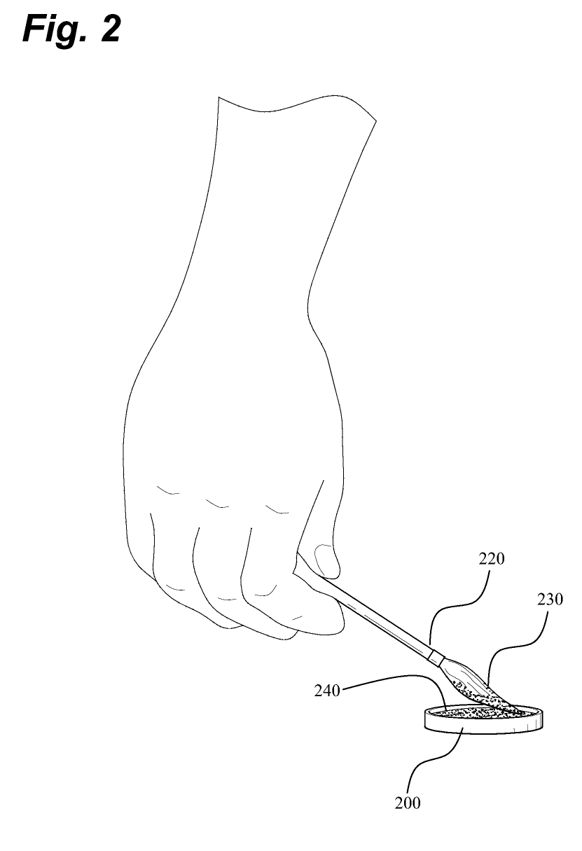

Referring now to the remaining Figures of which FIG. 2 shows a brush 220 with a bristle end 230 being dabbed on dog nose powder 240 held in container 200. The dog nose powder 240 is transferred to the bristle end 230 of brush 220 and thence used to powder coat at least one dog smudge 300 previously deposited by a playful dog on, for example, a window surface WS; applying dog nose powder 240 to at least one dog nose smudge 300 provides a corresponding set of at least one nose powder coated dog smudges 305 (see, e.g., FIG. 15A), which are then transferred to surface 260 of layer 140 (see, e.g., FIGS. 16 and 17).

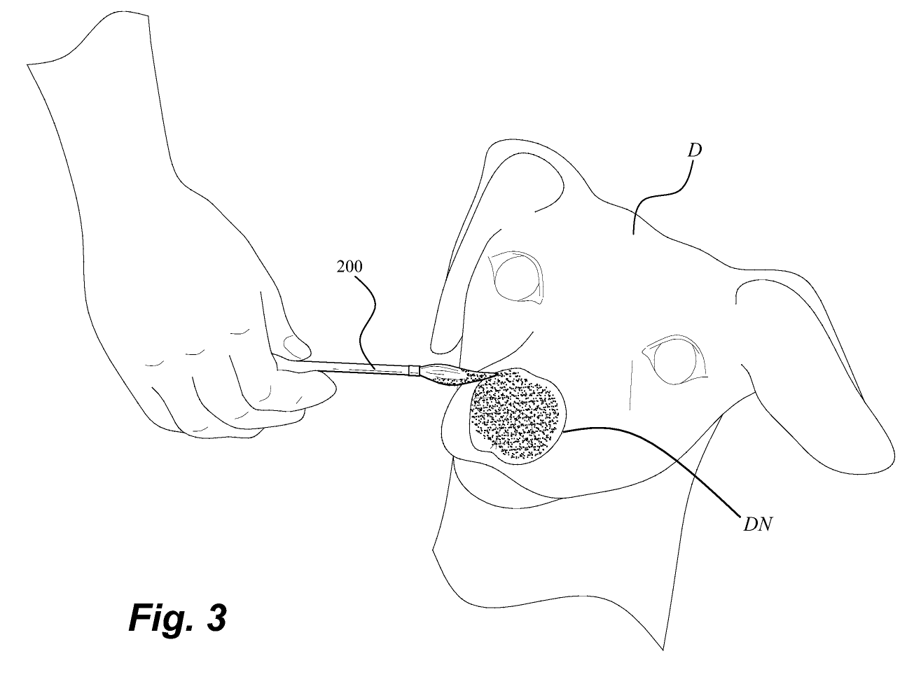

Alternatively, the dog nose powder 240 is used to directly coat a dog's nose as shown in FIG. 3 and dog smudges transferred to surface 260 of layer 140 (FIGS. 4 and 5). However, it is preferred to apply dog nose powder 240 to at least one dog nose smudge 300 previously deposited by a dog directly onto a window surface WS as shown (see FIG. 15A).

Referring to FIGS. 4 and 5, at least one dog nose smudge 300 is shown being transferred to surface 260 of dog smudge display layer 140. More specifically, separate parts of the surface 260 are pressed lightly against the nose powder covered dog nose DN to provide at least one nose powder coated dog nose smudge 305 on the surface 260.

It will be understood that if a dog shows signs of distress or discomfort the brush 220 can instead be used to powder dog smudges 300 on a non-animal surface such as a glass window, an exemplar of which is shown in FIG. 12, and the powdered dog smudges transferred from the glass window surface WS to the surface 260 of dog smudge display layer 140.

Referring to FIG. 6, the layers 120, 140, 160 and 180 are arranged as shown; which when pressed or layered on top of each other provide a dog nose smudge laminate 320. In more detail, the dog smudge display layer 140 defines a surface 260 and further defines a bottom surface 150. The base layer 120 defines a top surface 130. The surfaces 130 and 150 are brought together, the transparent protective layer 160 placed over the top surface 260 and the top window layer 180 placed over the transparent protective layer 160 taking care to ensure that the at least one nose powder coated dog nose smudge 305 are visible through window aperture 280.

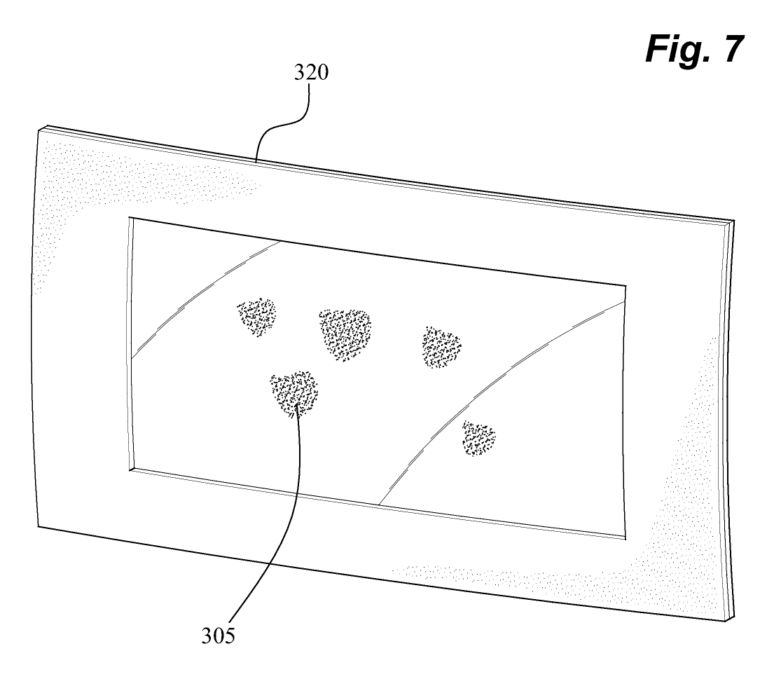

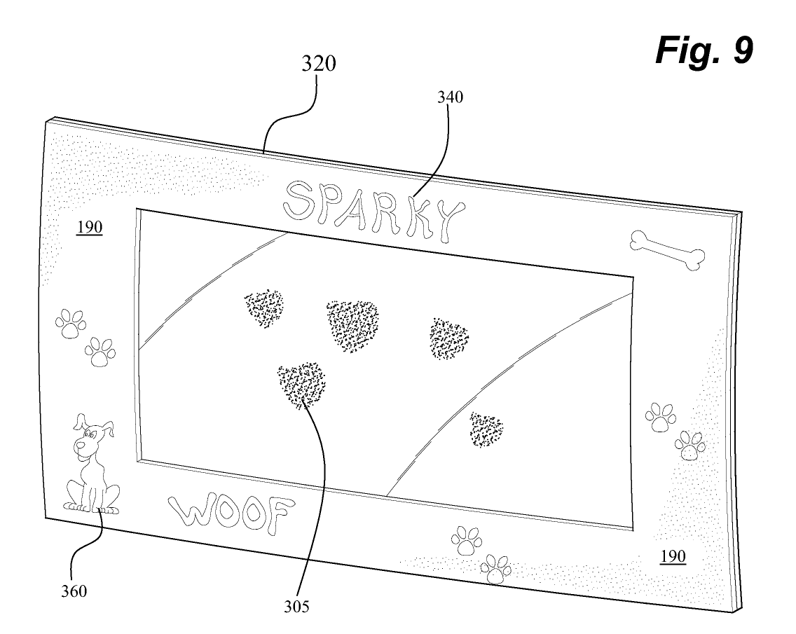

FIG. 7 shows an exemplar dog nose smudge laminate 320, which can be further enhanced as a decorative art form by adding indicia 340 and/or images 360 such as dog (e.g., puppy images). For example, indicia 340 and/or images 360 can be disposed as desired onto the top surface 190 of the top window layer 180 (see FIG. 8), and the indicia 340 can include the name of a pet dog (see FIG. 9 where the name “Sparky” is used as an exemplar dog name). Alternatively, puppy image stickers can be used from third party sources such as from a “puppy fun” stickers strip supplied by Frances Meyer®, Inc., a division of Chartpak, Inc. located at Leeds, Mass. 01053, Tel #: 413-584-5446.

The base layer 120 and/or top window layer 180 can be made of a magnetic material to facilitate attachment of the dog nose smudge laminate 320 in its completed form (e.g., as shown in FIG. 7) to, for example, a kitchen Bridge. For example, the base layer 120 and/or top window layer 180 can be made, wholly or at least in part, of a rubbery synthetic material in which magnetic ferrite particles have been embedded by a process as described in U.S. Pat. No. 5,621,369 (issued to Gardner et al. on Apr. 15, 1997). U.S. Pat. No. 5,621,369 is herein incorporated by reference in its entirety.

In one aspect of the invention the top window layer 180 in kit 100 (e.g., see FIG. 1) and in kit 400 (see FIG. 10) includes a plurality of magnetic ferrite particles embedded therein. In one aspect of the invention the base layer 120 includes a plurality of magnetic ferrite particles embedded therein.

In one embodiment of the present invention a method of providing a dog nose smudge laminate 320, comprising the steps of: applying dog nose powder 240 to a dog's nose DN to provide a powdered dog nose; collecting at least one dog smudge 300 from the powdered dog nose, wherein the at least one dog smudge 300 is collected on a surface 260 of a dog smudge display layer 140; applying a transparent layer 160 over the surface 260 of the dog smudge display layer 140; and sandwiching the dog smudge display layer 140 and the transparent layer 160 between a top window layer 180 and a base layer 120 to provide a dog nose smudge laminate 320, wherein the top window layer 180 defines a window aperture 280 enabling an observer to see the at least one dog smudge 300 through the transparent layer 160.

In a further embodiment of the present invention a “My Dog ‘Nose Art’” kit 400 (see FIG. 10) is provided to enable a dog lover or owner to obtain a permanent reminder of a beloved dog. The dog art kit 400 comprises at least some of the items shown in FIG. 10, including: at least one cotton ball 380, chalk 410, sandpaper 420, transparent layer 160, a dog smudge display layer 140, a display card 440, and an optional instructions list sheet 460. The display card 440 defines a surface area 450. The dog smudge display layer 140 defines a surface 260. The dog smudge display layer 140 can be opaque and surface 260 can be sticky. For example, dog smudge display layer 140 can be an opaque sticky tape comprising a sticky surface, e.g., white colored sticky tape. Alternatively, dog smudge display layer 140 can be opaque paper (e.g., white paper) comprising a sticky surface.

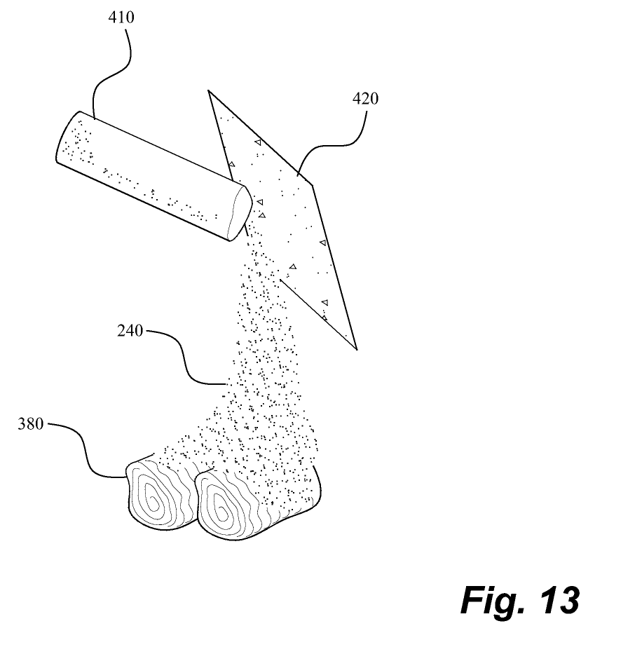

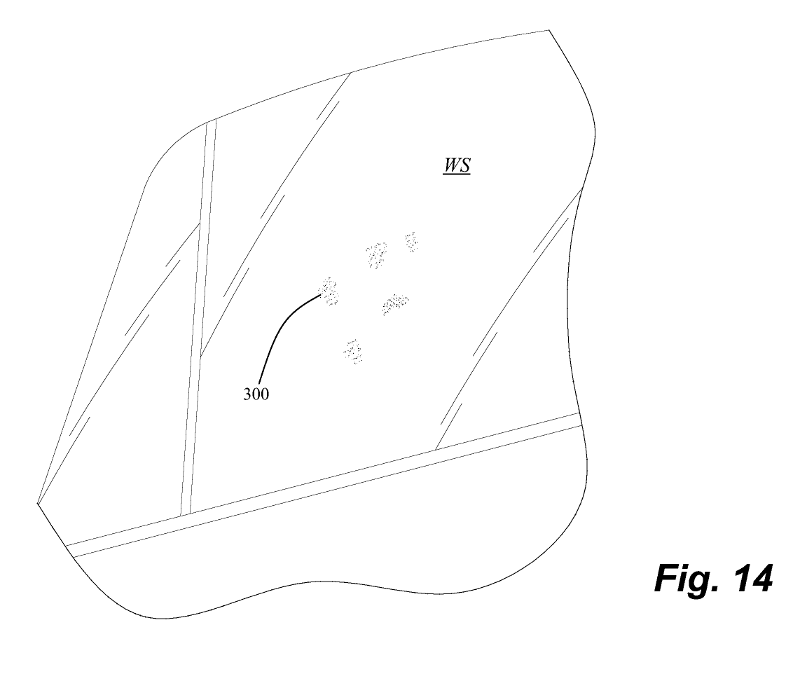

The kit 400 (shown in FIG. 10) is used, for example, to transfer at least one dog smudge 300 from a first surface (such as a window surface SW, see, e.g., FIG. 12), to surface 260 of dog smudge display layer 140 (see FIGS. 16 and 17). The sandpaper 420 can be used to rub chalk 410 to provide dog nose powder (see FIG. 13), which in turn can be applied to the at least one dog smudge 300 on window surface WS. For example, at least one cotton ball 380 can be used to coat at least one dog smudge 300 on surface WS with powder ((see FIG. 15). At least one dog smudge 300 is transferred to surface 260 on layer 140 by bringing surface 260 into contact with at least one dog smudge 300 on the window surface WS whereupon at least one dog smudge is transferred to surface 260 of layer 140 (see FIGS. 16 and 17).

Upon transfer of dog smudge 300 to the surface 260, the layer 140 is placed on surface 450 with surface 260 positioned face-up, and a transparent protective layer 160 placed over the surface 260. Alternatively, upon transfer of dog smudge 300 to the surface 260, a transparent protective layer 160 is placed over the surface 260 to provide a laminate comprising of layers 140 and 160, which are then placed transferred to surface 450 with surface 260 positioned face-up.

The chalk 410 can be a pastel chalk to render pastel chalk powder upon rubbing with sandpaper 420. In FIG. 10 the chalk 410 is shown as a cylindrical piece of chalk. However, chalk 410 is expressly not limited to a cylindrical shape and can be any shape with any cross-section shape such as circular, square or rectangular cross-section shape. The cross-section shape of the chalk 410 can have a regular or irregular polygonal shape. Alternatively, chalk 410 can comprise several shades of pastel chalks. For example, chalk 410 can be a Craf-T® Pastel Chalk Kit supplied by Craf-T Products®.

The “My Dog ‘Nose Art’” kit 400 enables, for example, a dog guardian or owner to take at least one dog nose smudge 300 off of a first surface, for example, a window surface WS (see, e.g., FIG. 12) and transfer the at least one dog nose smudge from the first surface to a second surface, for example, surface 450 on display card 440. The display card 440 can be placed, for example, on the front of a fridge or into books such as, but not limited to, family albums and pet remembrance books.

In another embodiment of the present invention, a method is provided for creating dog nose art, which includes the steps of: transferring at least one dog nose smudge from a first surface (e.g., a dog smudge covered window surface or directly from a dog's nose) onto an opaque sticky surface capable of retaining the at least one dog nose smudge; covering at least part of the opaque sticky surface with a transparent protective covering to provide a laminate; and affixing the laminate to a display surface so that the at least one dog nose smudge is visible through the transparent protective covering. The display surface may include a predetermined design disposed thereon. The predetermined design can include predetermined humorous writings and/or and predetermined humorous images.

With regard to kit 400, the dog smudge display layer 140 and/or display card 440 and/or optional instructions list sheet 460 include a plurality of magnetic ferrite particles embedded therein to facilitate attachment to, for example, the surface of a kitchen bridge. More specifically, item numbers 140, 440 and 460 of kit 400 can be individually or in any combination made, at least in part, of magnetic material. For example, the display card 440 and/or display card 440 and/or optional instructions list sheet 460 can be made at least in part of a rubbery synthetic material in which magnetic ferrite particles have been embedded by a process as described in U.S. Pat. No. 5,621,369 (issued to Cardner et al. on Apr. 15, 1997).

The invention being thus described, it will be evident that the same may be varied in many ways by a routineer in the applicable arts. Such variations are not to be regarded as a departure from the spirit and scope of the invention and all such modifications are intended to be included within the scope of the claims.

I claim:

1. A method of providing a dog nose smudge laminate (320), comprising:
applying dog nose powder (240) to at least one dog nose smudge (300) to provide at least one nose powder coated dog nose smudge (305);
collecting said at least one nose powder coated dog nose smudge (305), wherein said at least one nose powder coated dog nose smudge (305) is collected on a surface (260) of a dog smudge display layer (140);
applying a transparent layer (160) over said surface (260) of said dog smudge display layer (140); and
sandwiching said dog smudge display layer (140) and said transparent layer (160) between a top window layer (180) and a base layer (120) to provide a dog nose smudge laminate (320), wherein said surface (260) is facing away from said base layer (120) such that said at least one nose powder coated dog nose smudge (305) disposed on said surface (260) is visible,
wherein said top window layer (180) defines a window aperture (280) enabling an observer to see said at least one nose powder coated dog nose smudge (305) through said transparent layer (160).

2. The method of providing a dog nose smudge laminate (320) according to claim 1, wherein said at least one dog nose smudge (300) is located on a window surface.

3. The method of providing a dog nose smudge laminate (320) according to claim 1, wherein said step of applying dog nose powder (240) to at least one dog nose smudge (300) to provide at least one nose powder coated dog nose smudge (305) further comprises the step of using a brush (220) to apply said dog nose powder (240) to at least one dog nose smudge (300) to provide at least one nose powder coated dog nose smudge (305).

5. The method of providing a dog nose smudge laminate (320) according to claim 1, wherein said base layer (120) comprises magnetic ferrite particles.

6. The method of providing a dog nose smudge laminate (320) according to claim 1, wherein said window layer (180) comprises magnetic ferrite particles.

7. A method of providing a dog nose smudge laminate, comprising:
using a brush to brush dog nose powder (240) on to at least one dog nose smudge (300) to provide at least one nose powder coated dog nose smudge (305), wherein said at least one dog nose smudge (300) is located on a window surface;
collecting said at least one nose powder coated dog nose smudge (305), wherein said at least one nose powder coated dog nose smudge (305) is collected on a surface of a dog smudge display layer;
applying a transparent layer over said surface of said dog smudge display layer; and
sandwiching said dog smudge display layer and said transparent layer between a top window layer and a base layer to provide a dog nose smudge laminate,
wherein said top window layer defines a window aperture enabling an observer to see said at least one nose powder coated dog nose smudge through said transparent layer.

8. A dog art kit (100), comprising:
a base layer (120);
a dog smudge display layer (140);
a transparent protective layer (160);
a top window layer (180);
a container (200) of dog nose powder (240); and
a brush for applying dog powder (240).

9. The dog art kit (100) according to claim 8, wherein said base layer (120) comprises magnetic ferrite particles.

10. The dog art kit (100) according to claim 8, wherein said top window layer (180) includes a plurality of magnetic ferrite particles embedded therein.
